(19) United States
(12) Patent Application Publication
(10) Pub. No.: US 2024/0409825 A1
(43) Pub. Date: Dec. 12, 2024

(54) PROCESS FOR PURIFYING A CRUDE PYROLYSIS OIL ORIGINATING FROM THE PYROLYSIS OF PLASTIC WASTE AND USE THEREOF

(71) Applicant: BASF SE, Ludwigshafen am Rhein (DE)

(72) Inventors: Oliver PILARSKI, Ludwigshafen am Rhein (DE); Lisa LOEBNITZ, Ludwigshafen am Rhein (DE); Daniel KOEPKE, Ludwigshafen am Rhein (DE); Armin LANGE DE OLIVEIRA, Heidelberg (DE); Christian MUELLER, Ludwigshafen am Rhein (DE); Monica HAAG, Ludwigshafen am Rhein (DE); Gisela HIEBER, Ludwigshafen am Rhein (DE); Michael SCHREIBER, Ludwigshafen am Rhein (DE); Julian MEYER-KIRSCHNER, Ludwigshafen am Rhein (DE); Michael LOHMANN, Ludwigshafen am Rhein (DE); Timo HENN, Ludwigshafen am Rhein (DE)

(21) Appl. No.: 18/700,426

(22) PCT Filed: Oct. 6, 2022
(86) PCT No.: PCT/EP2022/077754

§ 371 Date: Apr. 11, 2024

(30) Foreign Application Priority Data
Oct. 15, 2021 (EP) 21202876.5

(51) Int. Cl. C10G 53/04; C10G 21/00; C10G 31/09

(52) U.S. Cl. CPC C10G 53/04; C10G 21/00; C10G 31/09; C10G 2300/1003

(57) ABSTRACT

A process for improving the quality of a crude pyrolysis oil originating from a pyrolysis of plastic waste is provided, the process comprising providing a crude pyrolysis oil originating from the pyrolysis of plastic waste, adjusting the pH value of the crude pyrolysis oil, resulting in a pretreated crude pyrolysis oil, performing a solid-liquid-separation of solid components and liquid components of the pretreated crude pyrolysis oil and/or subjecting the pretreated crude pyrolysis oil to a liquid-liquid-separation.

The present invention relates to a process for purifying a crude pyrolysis oil originating from the pyrolysis of plastic waste, in particular to obtain a pyrolysis oil having a reduced content of contaminating elements compared with the initially provided crude pyrolysis oil. Contaminating elements are, e.g., nitrogen, sulfur, acids, water, solids, halogens and metals.

The present invention further relates to the use of the crude pyrolysis oil treated in a process in accordance with the present invention.

Currently, plastic waste is still largely landfilled or incinerated for heat generation. Chemical recycling is an attractive way to convert waste plastic material into useful chemicals. An important technique for chemically recycling plastic waste is pyrolysis. The pyrolysis is a thermal degradation of plastic waste, typically in an inert atmosphere, and yields value added products such as pyrolysis gas, liquid pyrolysis oil and char (residue), wherein pyrolysis oil is the major product. The pyrolysis gas and char can be used as fuel for generating heat, e.g., for reactor heating purposes. The pyrolysis oil can be used as source for syngas production and/or processed into chemical feedstock such as ethylene, propylene, C4 cuts, etc. for example in a cracker, preferably in a steam cracker.

Typically, the plastic waste is mixed plastic waste composed of different types of polymers, such as, e.g., low density polyethylene (LDPE), high density polyethylene (HDPE), polystyrene (PS), polypropylene (PP) and/or polyvinyl chloride (PVC). The polymers are often composed of carbon and hydrogen in combination with other elements such as chlorine, fluorine, sulfur and nitrogen that often complicate recycling efforts. The elements other than carbon and hydrogen may be harmful during the further processing of the crude pyrolysis oil, since they may deactivate or poison catalysts used in the further processing of the pyrolysis oil.

During (steam) cracking, halogen-containing compounds can damage the cracker by corrosion in that they release hydrogen halide. Sulfur-containing compounds can deactivate or poison catalysts used in the cracker, or can contaminate the cracker products. Nitrogen-containing impurities may also poison downstream catalysts. In addition, they may cause a safety problem by forming explosive NOx when heated.

When mixed plastics containing polyvinyl chloride (PVC) are thermally degraded, compounds having double carbon bonds and hydrogen chloride are formed. The hydrogen chloride liberated from PVC attacks the compounds having carbon-carbon double bonds leading to the formation of chloro organic compounds. Plastic waste typically contains heteroatom-containing additives such as stabilizers and plasticizers that have been incorporated to improve the performance of the polymers. Such additives also often comprise nitrogen, halogen and sulfur containing compounds and heavy metals. In particular, the heavy metals are often toxic, and the quality of the pyrolysis oil is reduced by the presence of heavy metal impurities.

Furthermore, plastic waste often may be or include uncleaned plastics with residue that may also contain elements other than carbon and hydrogen. Therefore, the reduction of the nitrogen, sulfur, halogen content in the pyrolysis oil as well as the heavy-metal content is essential for any profit-generating processing of the pyrolysis oil. Especially, a high-quality pyrolysis oil rich in carbon and hydrogen and low in elements other than carbon and hydrogen is preferred as feedstock to prevent catalyst deactivation and corrosion problems in downstream refinery processes.

In addition to the challenges in connection with handling of the crude pyrolysis oil as described above, typically larger amounts of water are present in the crude pyrolysis oil due to the origin of the plastics as municipal waste. Water may also be harmful for the further processing of the crude pyrolysis oil as preparation step for feeding either into a syn gas process or in a (steam) cracker unit, since it may deactivate or poison catalysts and/or lead to fouling in process equipment.

Furthermore, water typically includes unwanted substances, such as nitrogen, sulfur, halogens and metals. Actually, the amount of unwanted substances contained in water (and the solid phase of the crude pyrolysis oil) is drastically higher than in the organic phase. This can be seen in the following table, which illustrates how much higher the content (relative content) of exemplary unwanted substances in a representative crude pyrolysis oil in the aqueous phase and the solid phase is compared to the content of the substances in the organic phase:

| | organic phase | aqueous phase | solid phase |
|---|---|---|---|
| Cl | 1 | 140 | 150 |
| N | 1 | 1.2 | 5 |
| S | 1 | 2.5 | 30 |
| Br | 1 | 70 | 85 |
| metals | 1 | 15 | 70 |

Crude pyrolysis oils having a high water content usually exhibit fouling after being stored for some time.

Furthermore, the formation of a solid precipitate in the crude pyrolysis oil is a major problem in the treatment of the crude pyrolysis oil. During pyrolysis as well as after transportation and during storage often a solid precipitate in the crude pyrolysis oil is formed. The solid precipitate can be characterized as star and/or sticky. This particular compound can lead to fouling in storage tanks and process equipment. Furthermore, due to the adhesion of the solids on its surface, the solid precipitate typically reduces accessibility of catalysts used in further processing of the pyrolysis oil.

General studies have shown that pyrolysis oil is typically more susceptible to oxidation and polymerization than refinery-made naphtha. Thus, crude pyrolysis oils have a gum-forming tendency due to the presence of conjugated diolefins, conjugated aromatic olefins or conjugated olefinic aldehydes/carboxylic acids (conjugated olefins summarized by diene number) or olefins (summarized by bromine number) in the presence of radical starters. Therefore, the resulting reactivity has to be handled during storage and processing of the crude pyrolysis oil. The mono- and diolefin content makes the crude pyrolysis oil prone to instability due to polymerization and the formation of deposits (i.e., gums).

In addition to the olefin content as originally present in the crude pyrolysis oil, storage stability of the crude pyrolysis oil is further influenced by the levels of heteroatoms (e.g., oxygen and nitrogen are acting as olefin polymerization catalysts). Dissolved oxygen may react with hydrocarbons forming carboxylic acids or peroxides and hydroperoxides. As a consequence, free-radical reactions may take place also starting radical-induced oligomerization/polymerization reactions.

Fouling processes in the crude pyrolysis oil may further be influenced by agglomeration. It is currently assumed that the crude pyrolysis oil is in a metastable state in which high molecular weight paraffins are in a dispersed state. When the crude pyrolysis oil is exposed to an uncontrolled pH variation, a thermal shock or a mechanical collision, the dispersed materials agglomerate and a dispersed solid phase result. Besides, the paraffins in asphaltene or bitumen can lead to a similar agglomeration effect.

As already mentioned, there is often water present in the crude pyrolysis oil. The water contained in the crude pyrolysis oil must be separated since it might be harmful for further downstream process steps. Water also increases the risk of corrosion in storage or process vessels. Furthermore, basically water free pyrolysis oil is in general more stable and has a reduced tendency for fouling. Fouling typically occurs at an interface between the organic and the aqueous phase. Thus, the tendency for fouling decreases if no or a minimized interface is present due to basically no aqueous phase being present.

EP 2 981 593 B1 discloses a process for conditioning synthetic crude oil, the process comprising obtaining synthetic crude oil by pyrolyzing one or more materials selected from polymer, plastic, and rubber materials, filtering the synthetic crude oil by passage of the synthetic crude oil through a filter media capable of capturing solid particulate material entrained within the synthetic crude oil, providing an aqueous process solution, wherein the aqueous process solution is a caustic process solution having a pH of between 8 and 10. The process further comprises providing a mixer suitable for mixing the synthetic crude oil and the process solution, determining a first volume of synthetic crude oil to be delivered to the mixer, calculating a second volume of aqueous process solution to be delivered to the mixer based on the first volume of synthetic crude oil required to maintain the pH of the synthetic crude oil and the process solution, once mixed, at a pH of between 8 and 10, mixing the first volume of synthetic crude oil with the second volume of the process solution, wherein the volume of the synthetic crude oil mixed with the process solution is less than the volume of process solution. The process further comprises delivering the mixture to a separator where conditioned synthetic crude oil is separated from the process solution and collecting the conditioned synthetic crude oil from the separator.

However, the interaction between the aqueous phase, organic phase and solid phase remains challenging to control. Solids mediate water to be emulsified in the organic phase, which can lead to major problems in liquid-liquid-separation steps as well as in solid-liquid-separation steps.

Accordingly, a process for upgrading plastic waste pyrolysis oil by reducing the nitrogen, sulfur, halogen content and preferably also the heavy metal content in the pyrolysis oil would be highly desirable. Furthermore, it would be desirable to provide a high-quality plastic waste pyrolysis oil that can be converted into high-value end products in an economic process.

In view of the above, it is an object to provide a process for improving the quality of pyrolysis oil originating from the pyrolysis of plastic waste by reducing its nitrogen, sulfur and halogen content, and, if present, preferably also the heavy metal content.

In particular, it is an object to provide a process for improving the quality of pyrolysis oil originating from the pyrolysis of a nitrogen-containing, sulfur-containing and halogen-containing plastic waste which can more easily be processed further, e.g., as feedstock for a (steam) cracker or feedstock for a partial oxidation due its reduced nitrogen, sulfur and halogen content, and in particular also reduced heavy metal content, in relation to an untreated pyrolysis oil.

It is a further object to provide a pyrolysis oil which has an improved storage stability and/or an improved processability.

Surprisingly, it has been found that these objects are achieved by a simple and economic process as explained below.

The objects described above are achieved by a process for purifying a crude pyrolysis oil originating from a pyrolysis of plastic waste according to claim 1.

According to the process, a crude pyrolysis oil originating from the pyrolysis of plastic waste is provided or obtained by pyrolysis.

In the context of the present invention, the term “pyrolysis oil” is understood to mean any oil originating from the pyrolysis of plastic waste.

In the context of the present invention, the term “pyrolysis” relates to a thermal decomposition or degradation of end-of-life plastics under inert conditions and results in a gas, a liquid and a solid char fraction. During the pyrolysis, the plastics are converted into a great variety of chemicals including gases such as H2, C1-C4-alkanes, C2-C4-alkenes, ethyne, propyne, 1-butyne, pyrolysis oil having a boiling temperature of 25° C. to 500° C. and char. The term “pyrolysis” includes slow pyrolysis, fast pyrolysis, flash catalysis and catalytic pyrolysis. These type of pyrolyses differ in the process temperature, heating rate, residence time, feed particle size, etc. resulting in different product quality.

The “plastic waste” to be pyrolyzed typically is mixed plastic waste. However, it is also possible to use plastic waste resulting from tires, plastic waste which is pure polymeric plastic waste, or film waste, including soiling, adhesive materials, fillers, residues etc.

The crude pyrolysis oil typically comprises a solid phase and a liquid phase, wherein the liquid phase includes an organic phase and an aqueous phase.

For example, a weight ratio between the aqueous phase and the organic phase in the liquid phase of the crude pyrolysis oil is about 0.01 or more, preferably about 0.05 or more, in particular about 0.2 or more.

For example, the weight ratio between the aqueous phase and the organic phase in the liquid phase of the crude pyrolysis oil is about 3.2 or less, preferably about 3.0 or less, in particular about 2.0 or less.

According to a preferred embodiment, the weight ratio between the aqueous phase and the organic phase in the liquid phase of the crude pyrolysis oil is about 0.2 to 0.4, for example about 0.3.

According to another preferred embodiment, a crude pyrolysis oil having a weight ratio between the aqueous phase and the organic phase from about 0.1 to about 3.1, for example from about 0.15 to about 3.0, in the liquid phase of the crude pyrolysis oil is used.

According to a further preferred embodiment, the crude pyrolysis oil has a weight ratio between the aqueous phase and the organic phase from about 0.02 to about 0.08, for example about 0.05, in the liquid phase.

According to the process, the pH value of the crude pyrolysis oil is adjusted, e.g., to a specified value, resulting in a pretreated crude pyrolysis oil.

The adjustment of the pH value of the crude pyrolysis oil reduces the tendency of the pretreated crude pyrolysis oil for fouling and/or increases the processability.

The adjustment of the pH value before a solid-liquid-separation can lead to a final pretreated crude pyrolysis oil with improved properties.

In the context of this description and the attached claims, “fouling” preferably means an accumulation of unwanted material (fouling materials). Fouling materials can comprise either living organisms (biofouling) or a non-living substance (inorganic or organic).

Due to the adjustment of the pH value, the technical manageability and/or processability of the pretreated crude pyrolysis oil is optimized compared to a pyrolysis oil without pH value control.

In particular, due to the adjustment of the pH value,
the filterability can be influenced; and/or
specific components can be separated from the rest; and/or
a separation velocity can be increased; and/or
storage stability can be improved.

As a consequence of the optimized properties of the pretreated crude pyrolysis oil compared to the untreated crude pyrolysis oil (such as better processability), smaller apparatuses and/or less complex apparatuses can be used in a further treatment.

Due to the solid-liquid-separation of the pretreated crude pyrolysis oil (i.e., after pH adjustment), a reduction of solid components can be achieved.

For example, the adjustment of the pH value can trigger further precipitation of (unwanted) solids. These (unwanted) solids can be separated from the remaining pretreated crude pyrolysis oil by a solid-liquid separation.

A separation velocity of the pretreated crude pyrolysis oil during a subsequent phase separation can be increased by a factor of 2 or more, for example by a factor of 5 or more, compared to a crude pyrolysis oil without pH adjustment.

In particular, a pretreated crude pyrolysis oil, the pH value of which has been adjusted (from initially 6.4) to be 9.5, has a separation velocity that is 5 times larger than the separation velocity of a crude pyrolysis oil which has not been subjected to a pH value adjustment and a solid-liquid-separation.

For example, a pretreated crude pyrolysis oil, the pH value of which has been adjusted to be 12.5, has a separation velocity that is 2.5 times larger than the separation velocity of a crude pyrolysis oil which has not been subjected to a pH value adjustment and a solid-liquid-separation.

According to a further example, the pH value of a crude pyrolysis oil has been adjusted from initially 6.4 to 1.5. A separation velocity of this pretreated crude pyrolysis oil having a pH value of 1.5 is 5 times larger than the separation velocity of a crude pyrolysis oil which has not been subjected to a pH value adjustment and a solid-liquid-separation.

In the context of the present description and the accompanying claims, the term “about” preferably means a deviation of the thus described value of +15%.

As mentioned, the pH value of the crude pyrolysis oil is adjusted, resulting in a pretreated crude pyrolysis oil. A crude pyrolysis oil, the pH value of which has been adjusted, is referred to as pretreated crude pyrolysis oil.

As already mentioned, preferably, a solid-liquid-separation of solid components and liquid components of the pretreated crude pyrolysis oil is performed after the pH value has been adjusted.

In the context of the present description and the accompanying claims, a liquid component/liquid phase and/or a solid component/solid phase typically specifies the physical state of the respective component/phase at 25° C. if not specified otherwise. All experiments were typically conducted at about 50° C. to about 90° C., for example at about 70° C. (if not specified otherwise). Thus, the respective state description refers to the physical state at the mentioned temperatures.

In addition to the performance of the solid-liquid-separation or in the alternative to the solid-liquid-separation of solid components and liquid components of the pretreated crude pyrolysis oil, the pretreated crude pyrolysis oil is subjected to a (first) liquid-liquid-separation, preferably an extraction.

The liquid-liquid-separation is preferably performed before the solid-solid-separation and can be considered as a first liquid-liquid-separation. This first liquid-liquid-separation serves removing water soluble undesired substances.

The first liquid-liquid-separation can also be regarded as a pre-separation, in which a first separation and/or purification is performed. In this first liquid-liquid-separation free water can be separated and discarded or recirculated. Furthermore, free organic phase can be separated within the first liquid-liquid-separation. The first pre-separation allows using smaller apparatuses in subsequent process steps compared to processes without pre-separation.

For example, for further purification of the organic phase, the organic phase can be recirculated and washed with extraction solution and/or basic aqueous solution or acidic aqueous solution. This work-up step can be repeated in one or more cycles. In addition or in the alternative, the organic phase can be washed with water to remove acid residues and/or base residues.

Terms such as “first”, “after”, “later” etc. refer to the time of the process and/or to a flow direction of the crude pyrolysis oil or its components along a process system.

Preferably, the pH value of the crude pyrolysis oil is adjusted to a be in a basic or in an acidic range.

The adjustment of the pH value in the basic or acidic range can increase the tendency of the pretreated crude pyrolysis oil to form a solid precipitate and/or may lead to an increased volume and/or increased weight of the solid phase. In particular, the solid precipitate formed by and/or after the adjustment of the pH value to a basic range or to an acidic range is insoluble in organic solvents, preferably polar aprotic solvents, for example acetone, tetrahydrofuran or mixtures thereof.

Typically, a basic pH value is a pH value that is about 7.5 or higher. An acidic pH value is typically a pH value that is about 6.5 or lower.

The pH value is typically measured under the use of a commercially available pH sensor. For example, a pH sensor with potassium chloride filling for measuring pH values from 0 to 14 at 0° C. to 80° C. can be used. Such a pH sensor is, e.g., commercially available under product no. 6.0234.100 from Deutsche METROHM GmbH & Co. KG, 70794 Filderstadt, Germany.

The process according to the invention can be performed as a continuous process. Alternatively, the process can be performed as a batch-process.

The pH value of the crude pyrolysis oil is preferably adjusted by the addition of an aqueous solution having a basic pH value or an aqueous solution having an acidic pH value. It can be beneficial if the aqueous solution contains one or more demulsifiers.

For example, an aqueous solution containing about 25 wt.-% alkali metal hydroxide, for example sodium hydroxide (NaOH), potassium hydroxide (KOH), alkaline earth metal hydroxide, for example calcium hydroxide (Ca(OH)₂, NH₃, or mixtures thereof, based on the total weight of the aqueous solution, is used for the adjustment of the pH value of the crude pyrolysis oil to be in a basic range.

Alternatively, an aqueous solution containing about 25 wt.-% sulfuric acid (H₂SO₄), nitric acid (HNO₃) or phosphoric acid (H₃PO₄), based on the total weight of the aqueous solution, is used for the adjustment of the pH value of the crude pyrolysis oil to be in an acidic range.

The inventors have observed, that separating free water, i.e., water that can be separated without separate filtration, and/or free organic phase from the crude pyrolysis oil is beneficial. In particular, the separation of free water and/or free organic leads to reduced volumes. Thus, smaller apparatuses can be used due to reduced volumes.

According to a preferred embodiment, the volume of the aqueous solution, with which the pH of the crude pyrolysis oil is adjusted, is smaller than the volume of the crude pyrolysis oil in total.

Preferably, the volume of the crude pyrolysis oil is at least by a factor of about 1.5, for example at least by a factor of about 2.0, larger than the volume of the aqueous solution added to the crude pyrolysis oil.

According to a preferred embodiment, the crude pyrolysis oil is provided in or transferred to a vessel, for example a mixing device, such as a stirrer. In this vessel, the crude pyrolysis oil is for example mixed with an aqueous solution having a basic pH value or an acidic pH value.

For mixing of components, preferably one or more than one mixing devices, for example more than one static stirrers, are used.

According to a preferred embodiment, the pH value of the crude pyrolysis oil is adjusted to be to about 6.5 or less, in particular about 3 or less, for example about 2 or less.

According to another preferred embodiment the pH value of the crude pyrolysis oil is adjusted to be about 8 or more, in particular about 9 or more, for example about 11 or more.

In accordance with a preferred embodiment, the liquid-liquid-separation, e.g., the extraction, is performed by mixing the pretreated crude pyrolysis oil with an extraction solution, wherein preferably the extraction solution is an aqueous solution, in particular a basic aqueous solution or an acidic aqueous solution.

Preferably, the liquid-liquid-separation is performed at a temperature of about 25° C. or more, in particular about 30° C. or more, and/or about 150° C. or less, in particular about 90° C. or less. For example, the liquid-liquid-separation is performed at about 70° C.

In embodiments, in which temperatures of about 100° C. to about 150° C. are used, preferably the respective component is kept in a pressure vessel as long as temperatures of about 100° C. or more prevail.

As described above, a solid-liquid-separation is performed. Preferred techniques to be used for solid-liquid-separation are filtration, centrifugation and/or decantation.

According to the present invention, preferably no extensive heating of the crude pyrolysis oil during before and/or during solid-liquid-separation is performed. For example, the crude pyrolysis oil is treated at the above-mentioned temperature range.

Preferably, performing a solid-liquid-separation comprises filtering of the pretreated crude pyrolysis oil or consists of filtering of the pretreated crude pyrolysis oil. Optionally, one or more filter aids are added to the pretreated crude pyrolysis oil before filtering the same.

Due to the solid-liquid-separation of the pretreated crude pyrolysis oil, preferably in form of a filtration, the phase separation of the solid and the liquid phase, and in particular regarding a later phase separation, is optimized.

Solid particles typically stabilize water-oil-dispersions and thus often complicate water removal from the crude pyrolysis oil. Due to the solid-liquid-separation, e.g., filtration, the velocity of the phase separation between the aqueous phase and the organic phase is drastically increased.

A separation velocity, for example during a subsequent liquid-liquid-separation, can be drastically increased.

For example, in embodiments in which the pretreated crude pyrolysis oil has been filtrated, the separation velocity of the pretreated crude pyrolysis oil is increased by a factor of 15 or more, preferably by a factor of 25 or more, compared to a pretreated crude pyrolysis oil, which has not been filtrated, having the same pH value.

According to one preferred embodiment, only one solid-liquid-separation, for example only one filtration step, needs to be performed to achieve a phase separation in the pretreated crude pyrolysis oil. More than one step is usually superfluous. Only one separation step can be advantageous regarding time needed for the performance of the process and consequently also regarding economic efficiency.

However, according to a further preferred embodiment, more than one solid-liquid-separation steps are incorporated into the process.

In embodiments, in which the solid-liquid-separation is a filtration, preferably, an average filtration velocity, e.g., at about 50° C., is about 0.04 kg/(h·cm²) or more, in particular about 0.05 kg/(h·cm²) or more.

The filtration velocity is typically defined as weight of the filtrate divided by the total filtration time and filtration area.

The weight of the filtrate can be measured by conventionally used balances, e.g., obtainable from Sartorius Lab Instruments Gmbh & Co. KG, 37079 Goettingen, Germany.

The total filtration time is, e.g., measured by determining the time from starting of the filtration process (e.g., bringing the pretreated crude pyrolysis oil in contact with a filter medium and starting with building up a pressure difference, e.g., by nitrogen gas) to the end of the filtration (e.g., when basically no more filtrate passes though the filter medium and nitrogen gas comes through a respective filter cloth).

Besides the separated crude pyrolysis oil from the solid-liquid-separation, a solid part, in case of filtration a solid filter cake, is obtained. The solid part typically contains undesired substances/contaminants, such as nitrogen, sulfur, halogens and/or metals. Therefore, the removal of the solid part already reduces the amount of undesired substances/contaminants.

For an optimized filtration result, one or more filtration aids can be used.

One, several or all of the one or more filter aids preferably comprises diatomaceous earth, cellulose, perlite or mixtures thereof or consists of diatomaceous earth, cellulose, perlite or mixtures thereof.

Preferably, the one or more filter aids are used in an amount of about 0.5 g filter aid per g solid or more and/or about 90 g filter aid per g solid or less.

For example, the one or more filter aids are used in an amount of about 0.05 wt.-% or more and/or about 5.0 wt.-% or less, based on the total weight of the pretreated crude pyrolysis oil. In particular, the one or more filter aids are used in an amount so that the pretreated crude pyrolysis oil comprises about 1 wt.-% or more and/or about 3.0 wt.-% or less filter aid, based on the total weight of the pretreated crude pyrolysis oil.

For example, about 2.5 wt.-% diatomaceous earth is used as filter aid, based on the total weight of the pretreated crude pyrolysis oil.

Preferably, the solid-liquid-separation is performed by using gravimetric forces or centrifugal forces or by building up a pressure difference.

The pressure difference can be built up by applying a vacuum or increased gas pressure, wherein for example the pressure difference is built up by using pneumatic pressure and/or hydraulic pressure.

For example, the pressure difference can be built up by using a pump element, such as a slurry pump, and/or a piston element.

In embodiments, in which the solid-liquid-separation is a filtration, due to the pressure difference, the liquid components of the pretreated crude pyrolysis oil are pressed through a filter element, e.g., a filter cloth, wherein solid components cannot pass the filter element. Thus, a separation of liquid components and solid components of the pretreated crude pyrolysis oil can be achieved.

It has been found to be beneficial to treat the crude pyrolysis oil and/or the pretreated crude pyrolysis oil at a low shear rate. Thus, preferably, elements such as stirring devices and conveying devices such as pump elements having a low shear rate are used. Pump elements having a low shear rate are, for example, membrane pumps and/or gear pumps.

Preferably, a power input per volume of a stirring device and/or a conveying device is about 200 W/m³ or more, more preferably about 450 W/m³ or more.

The power input per volume of a stirring device and/or a conveying device is preferably about 16500 W/m³ or less, in particular about 1000 W/m³ or less.

Due to the observed shear sensitivity of the crude pyrolysis oil, in particular one-stage axial pumping agitators with a low d/D (agitator diameter/vessel diameter) ratio should be avoided.

It is beneficial to use a stirring device and/or a conveying device having a high Newton number, for example a Newton number of about 2 or more. For example, one of the following stirring devices is used:
a two-stage three curved blade agitator having a Newton number of about 6; or
a blade agitator having a Newton number of about 5 to about 7; or a disk agitator having a Newton number of about 4.5.

After the solid-liquid-separation and/or the liquid-liquid-separation, for example the extraction, preferably a further liquid-liquid-separation is performed, wherein preferably the further liquid-liquid-separation is performed by using gravimetric forces and/or centrifugal forces.

The further liquid-liquid-separation is preferably a phase separation step in which the aqueous phase and the organic phase of the pretreated crude pyrolysis oil are separated.

For example, the aqueous phase and the liquid phase are separated in a further liquid-liquid-separation, wherein the pretreated crude pyrolysis oil is, preferably after filtration, positioned in a gravimetric settler.

Preferably, after the phases have settled, the phase having the higher density is separated from the phase having the lower density.

In addition (as a subsequent or preceding step) or instead of a gravimetric settler, a centrifuge or a cyclonic separation device, e.g., a hydrocyclone, can be used for separating the aqueous phase from the organic phase.

The further liquid-liquid-separation is preferably performed at a temperature of about 25° C. or more, in particular about 30° C. or more, and/or about 150° C. or less, in particular about 90° C. or less. For example, the further liquid-liquid-separation is performed at about 70° C.

For the further liquid-liquid-separation one or more internal structural elements can be used. Preferably, the one or more internal structural elements are selected from the group consisting of meshes, e.g., knitted meshes and/or woven meshes, random packings, plates and structured packings.

An optimization of the further liquid-liquid-separation is possible, for example, by a variation of the mass ratio of the aqueous phase and the organic phase. In accordance with a preferred embodiment, the mass ratio between the aqueous phase and the organic phase is adjusted to be 0.01:1 or more and/or about 2:1 or less. For example, the mass ratio between the aqueous phase and the organic phase is adjusted to be about 0.2:1 for optimized separation.

Before, during or after the aqueous phase has been separated from the organic phase or is separated, one or more further filter elements can be used to further improve the quality of the phase separation. Preferably, one or more further filter elements include or consist of a coalescence filter element.

Thus, the further liquid-liquid-separation can be further improved, e.g., by removing liquid entrainment (e.g., water). For example, liquid entrainment such as dispersed droplets can be removed with a coalescence filter. In contrast to the filter which can be used for the solid-liquid-separation, a direction of flow through the coalescence filter is preferably from inside to the outside.

It is possible that the organic phase which has been obtained from the further liquid-liquid-separation is recirculated and/or fed back to the pretreated crude pyrolysis oil, preferably at a stage of the process after the pretreated crude pyrolysis oil is subjected to the solid-liquid-separation and/or before the further liquid-liquid-separation.

Preferably, the aqueous phase which has been obtained from the further liquid-liquid-separation is recirculated and/or fed back to the pretreated crude pyrolysis oil, preferably at a stage of the process after the pretreated crude pyrolysis oil is subjected to the solid-liquid-separation and/or before the further liquid-liquid-separation.

For example, the phase ratio between the aqueous phase and the organic phase can be adjusted by recirculating parts of the aqueous phase which is obtained from the further (final) liquid-liquid-separation.

In addition or in the alternative, a residue, in particular crud and/or detritus, which has been separated from the pretreated crude pyrolysis oil is recirculated and/or fed back to the pretreated crude pyrolysis oil to a stage before the solid-liquid-separation.

Crud is in particular formed and/or accumulates at an interphase between the organic phase and the aqueous phase. Thus, preferably, the residue and/or crud is removed from the interphase between the aqueous phase and the organic phase.

A removal and/or recirculation of the residue and/or crud from the interphase between the aqueous phase and the organic phase allows the solid components to be separated. A growth or accumulation of residue and/or crud can thus be avoided.

It has been found to be beneficial that the residue that has been separated from the pretreated crude pyrolysis oil is recirculated and/or fed back to the pretreated crude pyrolysis oil at a stage of the process before the pretreated crude pyrolysis oil is subjected to the solid-liquid separation.

According to preferred embodiments, any substances that is recirculated and/or fed back is supplied into a mixing device.

In some embodiments, more than one mixing device and more than one liquid-liquid-separation is operated/performed in parallel. Furthermore, more than one further mixing device can be operated.

Optional, the process system can comprise every element twice. Thus, quick reactions in case of fouling without unnecessary downtimes are possible.

For example, it is possible that two process lines are arranged parallel to each other. Each process line comprises preferably one mixing device and a device for the liquid-liquid-separation.

In particular, the two process lines can be operated sequentially so that only one process line is under operation and the other one can be cleaned. Thus, the system does not have to be shut down in case one process line is cleaned and/or for maintenance measures.

However, it is also possible to operate the two process lines simultaneously.

Thus, it is possible that the crude pyrolysis oil is separated in two parts and that an aqueous solution having a basic pH value or an aqueous solution having an acidic pH value, both optionally containing demulsifier, is added to both parts of the crude pyrolysis oil so that two mixtures are formed. The mixtures are preferably mixed separately in two mixing devices. The two parts preferably have essentially the same volume.

Each mixing device is preferably fluidically connected to a device in which a liquid-liquid-separation can be performed. Preferably, the two devices in which the liquid-liquid-separation is performed are fluidically connected to each other.

As already mentioned, preferably, two process lines each comprising a mixing device and a device for liquid-liquid-separation are connected and/or operated in parallel.

Both mixing devices preferably comprise an aqueous phase supply and an organic phase supply, respectively, through which aqueous phase and organic phase can be recirculated into the process.

For further purification, preferably the main part of the pretreated crude pyrolysis oil, which has not been separated, is subjected to at least one additional solid-liquid-separation, preferably before a further (final) liquid-liquid separation.

Independent of the number of process lines, it is particularly preferred to subject the aqueous phase to a further solid-liquid-separation in the form of a filtration after the further liquid-liquid-separation in which the aqueous phase and the organic phase have been separated. Furthermore, the organic phase can also be subjected to a further purification, for example, by washing the organic phase with additional water.

Organic phase and/or aqueous phase are preferably fed back and/or recirculated into the process into an additional mixing device.

In order to provide an adaptable process, it is preferred that organic phase can be fed to the pretreated crude pyrolysis oil at the following states/stages of the process:
between the first mixing of the crude pyrolysis oil and the aqueous solution for adjusting of the pH value and the (first) liquid-liquid-separation;
before the further liquid-liquid-separation.

In order to provide an adaptable process, it is preferred that aqueous phase can be fed to the pretreated crude pyrolysis oil at the following states/stages of the process:
between the first mixing of the crude pyrolysis oil and the aqueous solution for adjusting of the pH value and the (first) liquid-liquid-separation;
before the further liquid-liquid-separation.

The mixing device(s) is/are preferably located at the following stages of the process:
between the first mixing of the crude pyrolysis oil and the aqueous solution for adjusting of the pH value and the (first) liquid-liquid-separation; and/or
between the (first) liquid-liquid-separation and the solid-liquid-separation; and/or
between the solid-liquid-separation and the further liquid-liquid-separation.

In embodiments in which the aqueous phase and/or the organic phase is entirely or partially recirculated and/or fed back to the process, it is preferred to use a further mixing device in order to ensure homogeneity.

In order to provide an adaptable process, it is preferred that organic phase can be recirculated and/or fed back to the pretreated crude pyrolysis oil at the following states/stages of the process:
before the liquid-liquid-separation;
before the further liquid-liquid-separation.

In order to provide an adaptable process, it is preferred that aqueous phase can be recirculated and/or fed back to the pretreated crude pyrolysis oil at the following states/stages of the process:
before the liquid-liquid-separation;
before the further liquid-liquid-separation.

In the alternative, the organic phase can also be partially removed at the following states/stages of the process:
after the liquid-liquid-separation;
after the further liquid-liquid-separation.

In the alternative, the aqueous phase can also be partially removed at the following states/stages of the process:
after the liquid-liquid-separation;
after the further liquid-liquid-separation.

Furthermore, the present invention relates to the use of a purified pyrolysis oil obtainable or obtained by a process in accordance with the invention as feedstock for a cracker, preferably a steam cracker, or as feedstock for a partial oxidation unit to produce syngas.

For the purposes of producing advantageous embodiments of the invention, particular ones or several of the features described in this description and the accompanying claims can be utilized or omitted at will in combination with further features or independently of further features.

Further preferred features and/or advantages of the present invention form the subject matter of the following description and the graphical illustration of exemplary embodiments.

In the drawings:

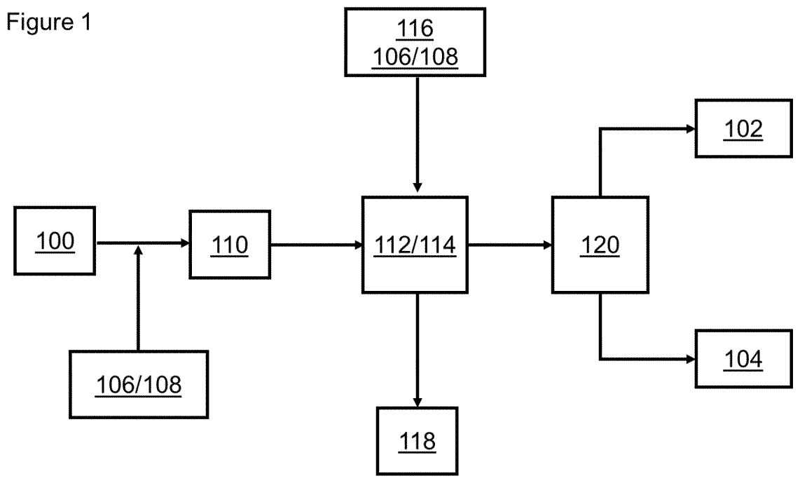

FIG. 1 schematically shows a first embodiment of a process for purifying and/or for improving the quality of a crude pyrolysis oil originating from the pyrolysis of plastic waste;

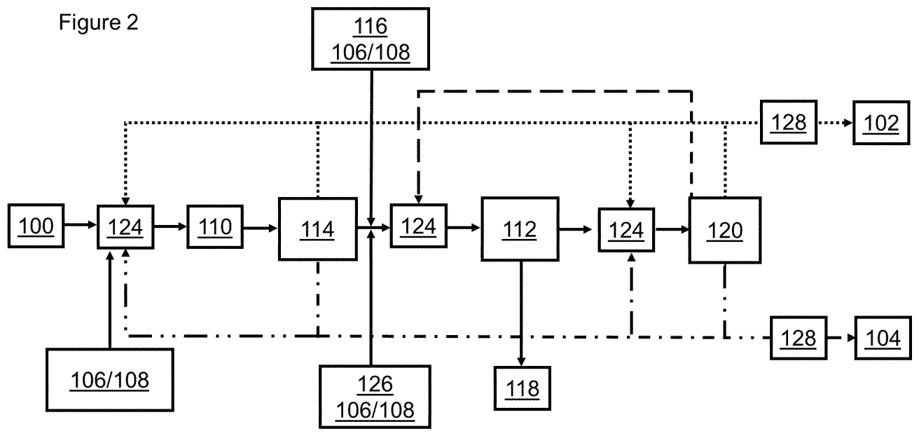

FIG. 2 schematically shows a further embodiment of a process for purifying and/or for improving the quality of a crude pyrolysis oil originating from the pyrolysis of plastic waste, wherein fluidic connections between different parts of the process system (system in which the process is performed) are shown; and

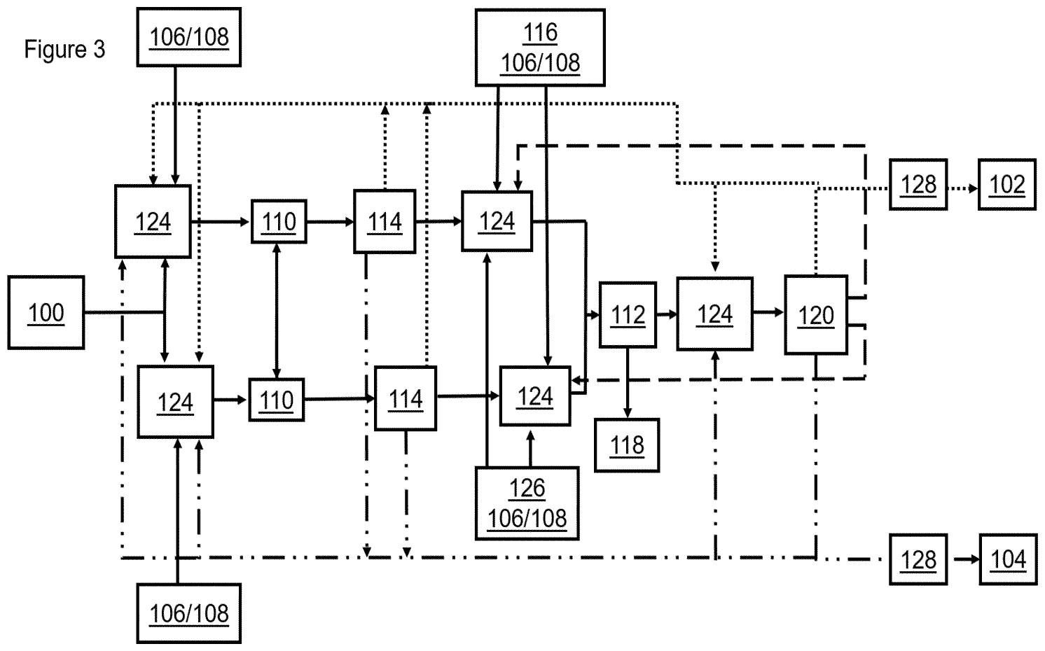

FIG. 3 schematically shows a further embodiment of a process for purifying and/or for improving the quality of a crude pyrolysis oil originating from the pyrolysis of plastic waste, wherein the embodiment comprises the provision of more than one mixing devices and more than one liquid-liquid-separation devices, wherein the more than one liquid-liquid separation devices are regarding a direction of flow of the pyrolysis oil located between first mixing devices and a further mixing device.

In FIG. 1, a first embodiment of a process for purifying a crude pyrolysis oil 100 originating from the pyrolysis of plastic waste is schematically shown.

With the embodiments shown in the FIGS. 1 to 3, a pretreated pyrolysis oil 110 having an improved quality compared to the untreated crude pyrolysis oil 100 is obtained.

In the Figures, a direction of flow of the respective components is indicated by an arrow.

In FIGS. 2 and 3, a flow and/or fluidic connections regarding an organic phase 102 is illustrated by a dotted line. A flow and/or fluidic connections regarding an aqueous phase 104 is illustrated by a dotdashed line (two dots and one line). A recirculation of residue (crud) is illustrated by a dashed line.

The recirculation paths shown in FIGS. 2 and 3 are equally valid for the embodiment of FIG. 1.

Preferably, according to the first embodiment of FIG. 1 a crude pyrolysis oil 100 entered into the process is treated such that an organic phase 102 and an aqueous phase 104 result. Solid components can be separated from the organic phase 102 and the aqueous phase 104.

An accordingly treated crude pyrolysis oil 100, in particular the organic phase 102, is particularly suitable (for example after hydroprocessing) for a subsequent use as feedstock for a cracker, in particular a steam cracker, or as feedstock for a partial oxidation unit to produce syngas (not graphically shown).

According to the process, a crude pyrolysis oil 100 originating from the pyrolysis of plastic waste is provided or obtained by pyrolysis.

The crude pyrolysis oil 100 typically comprises a solid phase and a liquid phase, wherein the liquid phase contains an organic phase and an aqueous phase.

The solid phase may increase in volume when the crude pyrolysis oil 100 (containing three phases) is stored, e.g., by sedimentation of solid particles.

In the crude pyrolysis oil 100, a weight ratio between the aqueous phase and the organic phase in the liquid phase of the crude pyrolysis oil is, e.g., about 0.01 or more, preferably about 0.05 or more, in particular about 0.2 or more.

For example, the weight ratio between the aqueous phase and the organic phase in the liquid phase is about 3.2 or less, preferably about 3.0 or less, in particular about 2.0 or less.

According to a preferred embodiment, the weight ratio between the aqueous phase and the organic phase in the liquid phase of the crude pyrolysis oil 100 is about 0.2 to 0.4, for example about 0.3.

Alternatively, a crude pyrolysis oil 100 having a weight ratio between the aqueous phase and the organic phase from about 0.1 to about 3.1, for example from about 0.15 to about 3.0, in the liquid phase of the crude pyrolysis oil 100 may be used.

According to a further alternative, a crude pyrolysis oil 100 having a weight ratio between the aqueous phase and the organic phase from about 0.02 to about 0.08, for example about 0.05, in the liquid phase may be used.

Preferably, the pH value of the crude pyrolysis oil 100 is adjusted to a desired value. Thus, the tendency of the pretreated crude pyrolysis oil 100 for fouling may be decreased and/or its processability increased.

Preferably, the pH value of the crude pyrolysis oil 100 is adjusted to a be in a basic or in an acidic range.

The adjustment of the pH value in the basic or acidic range can increase the tendency of the pretreated crude pyrolysis oil 100 to form a solid precipitate and/or may lead to an increased volume and/or increased weight of the solid phase. Thus, the solid components can be removed (in a solid-liquid-separation) and a subsequent liquid-liquid-phase separation can be optimized.

The pH value is typically measured under the use of a commercially available pH sensor, e.g., a pH sensor available under product no. 6.0234.100 from Deutsche METROHM GmbH & Co. KG, 70794 Filderstadt, Germany (which is a pH sensor with potassium chloride filling for measuring pH values from 0 to 14 at 0° C. to 80° C.).

The process according to the invention can be performed as a continuous process. Alternatively, the process can be performed as a batch-process.

The pH value of the crude pyrolysis oil 100 is preferably adjusted by the addition of an aqueous solution 106 having a basic pH value or by the addition of an aqueous solution 108 having an acidic pH value.

The aqueous solution 106, 108 can contain one or more demulsifiers.

For example, an aqueous solution 106 containing about 25 wt.-% alkali metal hydroxide, for example sodium hydroxide (NaOH), potassium hydroxide (KOH), alkaline earth metal hydroxide, for example calcium hydroxide (Ca(OH)₂, NH₃, or mixtures thereof, based on the total weight of the aqueous solution 106, is used for the adjustment of the pH value of the crude pyrolysis oil 100 to be in a basic range.

Alternatively, an aqueous solution 108 containing about 25 wt.-% sulfuric acid (H2SO₄), nitric acid (HNO₃) or phosphoric acid (H3PO₄), based on the total weight of the aqueous solution 108, is used for the adjustment of the pH value of the crude pyrolysis oil 100 to be in an acidic range.

The inventors have observed, that removing free water, i.e., water that can be separated without filtration, and/or free organic phase from the crude pyrolysis oil is beneficial. Thus, the quality of the pyrolysis oil can be optimized. Furthermore, smaller apparatuses can be used for the following process steps.

According to a preferred embodiment, the volume of the aqueous solution 106, 108 with which the pH of the crude pyrolysis oil 100 is adjusted is smaller than the volume of the crude pyrolysis oil 100.

Preferably the volume of the crude pyrolysis oil 100 is by a factor of about 1.5 or more, for example 2.0 or more, larger than the volume of the aqueous solution 106/108.

Free water, that can be separated from the crude pyrolysis oil 100, is separated therefrom. Furthermore, free organic phase can be separated.

In a preferred embodiment, the crude pyrolysis oil 100 is provided or transferred to a vessel, for example an extraction device. In this vessel, the crude pyrolysis oil 100 is mixed with an aqueous solution having a basic pH value or an acidic pH value.

According to a preferred embodiment, the pH value of the crude pyrolysis oil 100 is adjusted to be to about 6.5 or less, in particular about 3 or less, for example about 2 or less.

According to another preferred embodiment, the pH value of the crude pyrolysis oil 100 is adjusted to be about 8 or more, in particular about 9 or more, for example about 11 or more.

The pH value of the crude pyrolysis oil is adjusted, resulting in a pretreated crude pyrolysis oil 110. In other words, a crude pyrolysis oil, the pH value of which has been adjusted, is in the following referred to as pretreated crude pyrolysis oil 110.

Preferably, a solid-liquid-separation 112 between solid components and liquid components contained in the pretreated crude pyrolysis 110 oil is performed, in particular after a liquid-liquid-separation 114.

Due to the adjustment of the pH value followed by the solid-liquid-separation 112, a separation velocity in a further liquid-liquid-separation 120 (phase separation), can be drastically enhanced.

A separation velocity of the pretreated crude pyrolysis oil 110 during a subsequent phase separation can be increased by a factor of about 2 or more, preferably by about 5 or more, compared to the separation velocity of a crude pyrolysis oil 100 that has not been subjected to a pH adjustment.

For example, a pretreated crude pyrolysis oil 110, the pH value of which has been adjusted to be 9.5 (from initially 6.4), has a separation velocity that is about 5 times larger than the separation velocity of a crude pyrolysis oil 100 which has not been subjected to a pH value adjustment and a solid-liquid-separation 112.

A pretreated crude pyrolysis oil 110, the pH value of which has been adjusted to be 12.5 (from initially 6.4), for example, has a separation velocity that is about 2.5 times larger than the separation velocity of a crude pyrolysis oil 100 which has not been subjected to a pH value adjustment and a solid-liquid-separation 112.

According to a further example, the pH value of a crude pyrolysis oil 100 has been adjusted from initially 6.4 to 1.5. A separation velocity of this pretreated crude pyrolysis oil 110 having a pH value of 1.5 is 5 times larger than the separation velocity of a crude pyrolysis oil 100 which has not been subjected to a pH value adjustment and a solid-liquid-separation 112.

In addition to the performance of the solid-liquid-separation 112 or in the alternative to the solid-liquid-separation 112 of the pretreated crude pyrolysis oil 110, the pretreated crude pyrolysis oil 110 may be subjected to a liquid-liquid-separation 114, preferably an extraction.

The liquid-liquid-separation 114 (if used in combination with the solid-liquid-separation 112) is preferably performed before the solid-liquid-separation 112.

The mentioned liquid-liquid-separation 114 presently is a pre-separation, in which a first separation of the aqueous phase and the organic phase is performed and contaminants and/or undesired substances can be dissolved or dispersed in an extraction solution 116 and removed from the organic phase 102.

In accordance with a preferred embodiment, the liquid-liquid-separation 114, e.g., the extraction, is performed by mixing the pretreated crude pyrolysis oil 110 with an extraction solution 116, wherein preferably the extraction solution 116 is an aqueous solution 106/108, in particular a basic aqueous solution or an acidic aqueous solution.

In particular for economic purposes and in order to keep the process as simple as possible, it might be beneficial to use an extraction solution 116 with the same physical and/or chemical properties as the aqueous solution 106 or the aqueous solution 108. It is also possible to reuse the aqueous solutions 106/108.

Preferably, the liquid-liquid-separation 114 is performed at a temperature of about 25° C. or more, in particular about 30° C. or more, and/or about 150° C. or less, in particular about 90° C. or less. A particularly preferred temperature to perform the liquid-liquid-separations 114 is at about 70° C.

In embodiments, in which temperatures of about 100° C. to about 150° C. are used, preferably the respective component is kept in a pressure vessel as long as temperatures of about 100° C. or more prevail.

It has already been mentioned that a solid-liquid separation 112 is performed. Preferred techniques to be used for the solid-liquid-separation 112 are filtration, centrifugation and/or decantation.

Presently, performing a solid-liquid-separation 112 comprises or consists of filtering of the pretreated crude pyrolysis oil 110. Optionally, one or more filter aids are added to the pretreated crude pyrolysis oil 110 before filtering the same.

Due to the filtration of the pretreated crude pyrolysis oil 110, the phase separation of the solid phase and the liquid phase is optimized.

For example, due to the filtration of the pretreated crude pyrolysis oil 110, the separation velocity of the phase separation between the aqueous phase and the organic phase is drastically increased, compared to the separation velocity without filtration.

For example, the separation velocity of the pretreated crude pyrolysis oil 110 which has been filtrated is increased by a factor of 15 or more, preferably by a factor of 25 or more, compared to the separation velocity of a crude pyrolysis oil 100 having the same pH value, which has not been filtrated.

In particular, only one solid-liquid-separation step, presently one filtration step, needs to be performed to achieve a phase separation in the pretreated crude pyrolysis oil 110. More than one step is usually superfluous.

However, according to further preferred embodiments, more than one solid-liquid-separation 112 steps can be incorporated into the process. Preferably, an average filtration velocity during the filtering of the pretreated crude pyrolysis oil 110 is about 0.04 kg/(h·cm²) or more, in particular about 0.05 kg/(h·cm²) or more.

The filtration velocity is typically defined as weight of the filtrate divided by the total filtration time and filtration area.

The weight of the filtrate can be measured by conventionally used balances, e.g., obtainable from Sartorius Lab Instruments Gmbh & Co. KG, 37079 Goettingen, Germany.

The total filtration time is, for example, measured by taking the time from starting of the filtration process (e.g., bringing the pretreated crude pyrolysis oil 110 in contact with a filter medium and applying nitrogen pressure) to the end of the filtration (e.g., when basically no more filtrate passes though the filter medium and nitrogen comes through).

One, several or all of the one or more filter aids 126 preferably comprises diatomaceous earth, cellulose, perlite or mixtures thereof or consists of diatomaceous earth, cellulose, perlite or mixtures thereof. The addition of the one or more filter aids 126 is schematically shown in FIG. 2 and FIG. 3. However, although not graphically shown, one or more filter aids 126 can be added according to the embodiment shown in FIG. 1, too.

Preferably, the one or more filter aids 126 are used in an amount of about 0.5 g filter aid/g solid or more and/or about 90 g filter aid/g solid or less.

For example, the one or more filter aids 126 are used in an amount of about 0.05 wt.-% or more, in particular about 1.0 wt.-% or more, based on the total weight of the pretreated crude pyrolysis oil 110.

In particular, the one or more filter aids 126 are used in an amount of about 5.0 wt.-% or less, for example about 3.0 wt.-% or less, with regard to the total weight of pretreated crude pyrolysis oil 110.

For example, 2.5 wt.-% of filter aid 126 in the form of diatomaceous earth is used, based on the total weight of the pretreated crude pyrolysis oil 110.

Preferably, the solid components and the liquid components of the pretreated crude pyrolysis oil 110 are separated by using gravimetric forces or centrifugal forces or by building up a pressure difference.

The pressure difference can be built up by applying a vacuum or increased gas pressure, wherein for example the pressure difference is built up by using pneumatic pressure and/or hydraulic pressure.

For example, the pressure difference can be built up by using a pump element, such as a slurry pump, and/or a piston element.

In embodiments, in which the solid-liquid-separation 112 is a filtration, due to the pressure difference, the liquid components of the pretreated crude pyrolysis oil are pressed through a filter element, e.g., a filter cloth, wherein solid components cannot pass the filter element. Thus, a separation of liquid components and solid components of the pretreated crude pyrolysis oil 110 can be achieved.

During filtration, typically a solid filter cake 118 is separated from the filtrate.

It has been found to be beneficial to treat the crude pyrolysis oil 100 and/or the pretreated crude pyrolysis oil 110 at a low shear rate. Thus, elements, such as stirring devices and conveying devices, e.g., pump elements, having a low shear rate are preferably used. Pump elements having a low shear rate are, for example, membrane pumps and/or gear pumps.

Preferably, a power input per volume of a stirring device and/or a conveying device is about 200 W/m³ or more, more preferably about 450 W/m³ or more. The power input per volume of a stirring device and/or a conveying device is preferably about 16500 W/m³ or less, in particular about 1000 W/m³ or less.

It is beneficial to use a stirring device and/or a conveying device having a high Newton number, for example a Newton number of about 2 or more. In particular multi-stage stirring devices are used.

For example, one of the following stirring devices is used:
a two-stage three curved blade agitator having a Newton number of about 6; or
a blade agitator having a Newton number of about 5 to about 7; or
a disk agitator having a Newton number of about 4.5.

After the liquid-liquid-separation 114, e.g., the extraction, and/or the solid-liquid-separation 112, preferably a further liquid-liquid-separation 120 is performed, wherein preferably the further liquid-liquid-separation 120 is performed by using gravimetric forces and/or centrifugal forces.

The further liquid-liquid-separation 120 is preferably a phase separation step in which the aqueous phase 104 and the organic phase 102 of the pretreated crude pyrolysis oil 110 are separated.

For example, the aqueous phase 104 and the organic phase 102 are separated in a liquid-liquid-separation 120, wherein the pretreated crude pyrolysis oil 110 is, preferably after filtration 112, positioned in a gravimetric settler.

After the phases have settled, the phase having the higher density is separated from the phase having the lower density.

In addition (as a subsequent or preceding step) or instead of a gravimetric settler, a centrifuge or a cyclonic separation device, e.g., a hydrocyclone, can be used for separating the organic phase 102 from the aqueous phase 104.

The further liquid-liquid-separation 120 is preferably performed at a temperature of about 25° C. or more, in particular about 30° C. or more, and/or about 150° C. or less, in particular about 90° C. or less. For example, the further liquid-liquid-separation 120 is performed at about 70° C. For the further liquid-liquid-separation 120 one or more internal structural elements can be used. Preferably, the one or more internal structural elements are selected from the group consisting of meshes, e.g., knitted meshes and/or woven meshes, random packings, plates and structured packings.

An optimization of the further liquid-liquid-separation 120 is possible, for example, by a variation of the mass ratio of the aqueous phase 104 and the organic phase 102. In accordance with a preferred embodiment, the mass ratio between the aqueous phase 104 and the organic phase 102 is adjusted to be 0.01:1 or more and/or about 2:1 or less. For example, the mass ratio between the aqueous phase 104 and the organic phase 102 is adjusted to be about 0.2:1 for optimized separation.

Before, during or after the organic phase 102 has been separated from the aqueous phase 104 or is separated, one or more further filter elements can be used to further improve the quality of the phase separation. Preferably one or more further filter elements include or consist of a coalescence filter element.

Thus, the liquid-liquid-separation 120 can be further improved, e.g., by removing liquid entrainment.

A further embodiment of a process for improving the quality of a crude pyrolysis oil 100 originating from a pyrolysis of plastic waste shown in FIG. 2 substantially differs from the embodiment shown in FIG. 1 in that a residue which has been separated from the pretreated crude pyrolysis oil 110 is recirculated and/or fed back to the pretreated crude pyrolysis oil 110 before the pretreated crude pyrolysis oil 110 is subjected to the solid-liquid separation 112.

Presently, the residue is a crud and/or detritus which accumulates at an interphase between the organic phase 102 and the aqueous phase 104. Thus, the crud is removed from the interphase between the aqueous phase 104 and the organic phase 102.

Presently, the crud is recirculated and/or fed back to the pretreated crude pyrolysis oil 110 at a stage of the process before the pretreated crude pyrolysis oil 110 is subjected to the solid-liquid separation 112. Preferably, the crud is recirculated and/or supplied to a further mixing device 124 located between the liquid-liquid-separation 114 and the solid-liquid-separation 112.

In the embodiment shown in FIG. 2, also a recirculation of the aqueous phase 104 which has been obtained from the further liquid-liquid-separation 120 is shown. By recirculating parts of the aqueous phase 104, the phase ratio between the aqueous phase 104 and the organic phase 102 can be adjusted. The aqueous phase 104 can be recirculated before the liquid-liquid-separation 114 and/or before the further liquid-liquid-separation 120. After the liquid-liquid-separation 114, parts of the aqueous phase 104 can also be removed from the process.

In the alternative or additionally, organic phase 102 which has been obtained from the further liquid-liquid-separation 120 can be recirculated and/or fed back to the pretreated crude pyrolysis oil 110, preferably at a stage of the process before the pretreated crude pyrolysis oil is subjected to the liquid-liquid-separation 114 and/or the further liquid-liquid-separation 120.

Organic phase 102 and/or aqueous phase 104 that is recirculated and/or fed back is preferably supplied to a process line into a mixing device 124 (either the first mixing device or an additional mixing device).

Just as the aqueous phase 104, parts of the organic phase 102 can also be removed from the process after the liquid-liquid-separation 114, for example, to adjust the phase ratio between the aqueous phase 104 and the organic phase 102.

According to the embodiment shown in FIG. 2, a mixture resulting from adding the aqueous solution 106 having a basic pH value and optionally containing demulsifier or the aqueous solution 108 having an acidic pH value and optionally containing demulsifier to the crude pyrolysis oil 100 is fed into a mixing device 124. In the mixing device 124, the components are mixed with each other so that the pretreated crude pyrolysis oil 110 with a controlled pH value is formed.

Optionally, further aqueous solution 106 having a basic pH value and optionally containing demulsifier or the aqueous solution 108 having an acidic pH value and optionally containing demulsifier can be added to the pretreated crude pyrolysis oil 110 for pH adjustment.

Furthermore, preferably one or more filter aids 126 are added.

Afterwards, the pretreated crude pyrolysis oil 110 is presently again fed into a further mixing device 124 for further mixing.

After the further mixing, the pretreated crude pyrolysis oil 110 is according to the embodiment of FIG. 2 subjected to a solid-liquid-separation 112, presently a filtration.

After the solid components have been separated and typically discarded, the remaining liquid components are subjected to a further liquid-liquid-separation 120 between the aqueous phase 104 and the organic phase 102.

Presently, between the solid-liquid-separation 112 and the further liquid-liquid-separation 120 an additional mixing device 124 is arranged for mixing recirculated phases with the filtrate.

In the embodiment shown in FIG. 2, the aqueous phase 104 is subjected to a further solid-liquid separation 128 after the further (final) liquid-liquid separation 120. Afterwards, the aqueous phase 104 can be led into a wastewater treatment.

Additionally, presently the organic phase 102 is subjected to a further solid-liquid separation 128 after the final liquid-liquid separation 120. Afterwards, the organic phase 102 can be led into a further treatment.

It is possible, to further purify the organic phase 102, for example, by washing with additional water.

As already mentioned, in order to provide an adaptable process, it is preferred that organic phase 102 can be recirculated and/or fed back to the pretreated crude pyrolysis oil 110 at the following states/stages of the process:
before the liquid-liquid-separation 114;
before the further liquid-liquid-separation 120.

In order to provide an adaptable process, it is preferred that aqueous phase 104 can be recirculated and/or fed back to the pretreated crude pyrolysis oil 110 at the following states/stages of the process:
before the liquid-liquid-separation 114;
before the further liquid-liquid-separation 120.

The aqueous phase 104 and/or the organic phase 102 can also be partially removed from the process at the mentioned stages.

A further embodiment of a process for improving the quality of a crude pyrolysis oil 100 originating from a pyrolysis of plastic waste shown in FIG. 3 substantially differs from the embodiment shown in FIG. 2 in that the process system comprises a further mixing device 124 and a further device for a liquid-liquid-separation 114.

Two process lines, each comprising mixing devices 124 and a device for liquid-liquid-separation 114, are formed, arranged in parallel to each other.

Accordingly, an aqueous solution 106 having a basic pH value or an aqueous solution 108 having an acidic pH value, both optionally containing demulsifier, is added to the crude pyrolysis oil 100 so that a mixture is formed.

The mixture is transferred in one of two process lines, each comprising a mixing device 124 and a device for liquid-liquid-separation 114.

Alternatively, if both process lines are operated simultaneously, the mixture is separated and fed, preferably in equal volumes, to two mixing devices 124. Each mixing device 124 is fluidically connected to a device in which a liquid-liquid-separation 114 can be performed. Preferably, the two devices in which the liquid-liquid-separation 114 is performed are fluidically connected to each other.

As mentioned, two units/process lines, each comprising a mixing device 124, a device for liquid-liquid-separation 114 and an additional/further mixing device 124, are connected and/or operated in parallel. Also, two solid-liquid-separation 112 devices can be part of the system (as mentioned).

Either a sequential or a simultaneous operation of the two process lines is possible.

After the liquid-liquid-separations 114 have been performed, aqueous phases 104 and organic phases 102 resulting from the liquid-liquid-separations 114 can already be collected and fed to further treatment and/or be recirculated and fed back to the pretreated crude pyrolysis oil 110 in a state before the first liquid-liquid separation 114.

After the first liquid-liquid-separation 114, the pretreated crude pyrolysis oil 110 is in both process lines fed into a further mixing device 124, respectively.

Afterwards, the pretreated crude pyrolysis oil 110 is presently recombined for further treatment.

After mixing in the further mixing device 124, a solid-liquid-separation 112, in particular a filtration, is performed.

After the solid-liquid-separation, preferably a liquid-liquid-separation 120 between the aqueous phase 104 and the organic phase 102 of the pretreated crude pyrolysis oil 110 is performed.

As can be seen from FIG. 3, it is beneficial if the system further comprises an additional mixing device 124 which is (seen in the direction of flow of the pyrolysis oil) preferably used between the solid-liquid separation 112 and the further liquid-liquid-separation 120.

In order to provide an adaptable process, it is preferred that organic phase 102 can be fed to the pretreated crude pyrolysis oil 110 into a mixing device 124, in particular at the following states of the process:
between the first mixing of the crude pyrolysis oil 100 and the aqueous solution 106, 108 for adjusting of the pH value and the liquid-liquid-separation 114;
before the further liquid-liquid-separation 120.

Organic phase 102 can be removed before and/or after the liquid-liquid-separations 114, 120.

In order to provide an adaptable process, it is preferred that aqueous phase 104 can be fed to the pretreated crude pyrolysis oil 110 into a mixing device 124, in particular at the following states of the process:
between the first mixing of the crude pyrolysis oil 110 and the aqueous solution 106, 108 for adjusting of the pH value and the liquid-liquid-separation 114;
before the further liquid-liquid-separation 120.

Aqueous phase 104 can be removed before and/or after the liquid-liquid-separations 114, 120.

In all other respects, in particular regarding the features and/or properties of the mentioned process steps, the embodiment shown in FIG. 3 corresponds to the embodiment shown in FIG. 2 so that it is referred to the description in this regard.

In the following, examples prepared according to the process of the invention are compared with reference examples:

Presently, a crude pyrolysis oil 100, containing unsolved water in an amount of about 0.5 wt.-% to about 70 wt.-% and about 2 wt.-% to about 8 wt.-% solids was used for experiments. The crude pyrolysis oil 100 was obtained by pyrolyzing mixed plastic waste.

In the examples, the pH value was adjusted before a solid-liquid-separation 112 (here: a filtration) was performed.

In reference examples, the pH value was adjusted after a solid-liquid-separation in form of a filtration has been performed.

The crude pyrolysis oil 100 used in the experiments is a three-phase mixture containing a solid phase, an organic phase and an aqueous phase. The crude pyrolysis oil 100 was heated up to about 70° C. The mixture was agitated for about 10 to about 30 min with a power input of about 400 W/m³.

The pH values were adjusted with an a basic of acidic aqueous solution 106, 108. As basic aqueous solution 106, a 25 wt.-% NaOH solution (based on the total weight of the aqueous solution) was used. As acidic aqueous solution 108 a 25 wt.-% H2SO₄ solution (based on the total weight of the aqueous solution) was used.

The pH value was measured in the agitated dispersion with a pH sensor (which measures pH values in the range from 0 to 14 in a temperature range from 0° C. to 80° C. having a KCl (potassium chloride) filling), available under product no. 6.0234.100, by Deutsche METROHM GmbH & Co. KG, 70794 Filderstadt, Germany.

For an optimized filtration velocity, a filter aid (e.g., about 0.05 wt.-% to about 5 wt.-% diatomaceous earth based on the total weight of the pretreated crude pyrolysis oil 110) was added to the pretreated crude pyrolysis oil 110. The mixture is heated up to 50° C. for 30 minutes. The mixture was afterwards added to a heated (50° C.) double-jacket nutsche filter with a filtration area of 20 cm² and a capacity of 1 l.

For the examples, a polypropylene filter cloth with a mesh size of 20 μm was used for filtration. The pretreated crude pyrolysis oil 110 was pressurized with nitrogen at a pressure difference of 0.5 bar. Filtrate flow was calculated based on continuously recording the filtrate mass via a balance.

The weight of the filtrate (filtrate mass) was measured by a conventionally used balance, obtainable from Sartorius Lab Instruments Gmbh & Co. KG, 37079 Goettingen, Germany.

Afterwards, phase separation of the filtrate was evaluated and compared to reference examples for which the pH value has been adjusted after the filtration.

According to the reference examples, the crude pyrolysis oil was filtered as described in connection with the examples according to the process of the invention.

For both, the examples and the reference examples, a liquid-liquid-separation was performed (which has been described as further liquid-liquid-separation 120 before) after the filtration.

For the liquid-liquid-separation 120, gravimetric forces were used.

Among other tests, a so-called spot test was run, respectively. Three drops (with a 1 ml syringe) of the filtrate in form of a dispersion are placed on a filter paper (MN 640d 2 μm to 4 μm, obtained from Macherey-Nagel GmbH & Co. KG, 52355 Dueren, Germany). The paper was dried in an oven for 1 h.

On the basis of the results of the spot test, the liquid-liquid-separation 120 (i.e., a phase separation) was evaluated based the amount of solid the filtrate (liquid phase) contained after solid-liquid-separation 112.

The spot tests show that the adjustment of the pH value to values of 1.5 to 12.2 for the examples led to a significant reduced solid content compared to the solid content of the reference examples (for which the pH values has been adjusted accordingly after the filtration).

Thus, the removal of solid components from the liquid phase is enhanced when the pH value is adjusted before the solid-liquid-separation 112, e.g., the filtration.

A liquid-liquid-separation 114 in form of an extraction before the filtration 112 might even increase the quality of the obtained organic phase 102.

For further purification of the organic phase 102, washing of the organic phase 102 with extraction solution 116 and/or aqueous solution 106/108 can be repeated in one or more cycles. In addition or in the alternative, the organic phase 102 can be washed with water to remove acid residues and/or base residues (not graphically shown).

Overall, a purified crude pyrolysis oil treated according to the process of the present invention has reduced content of nitrogen, sulfur, acids, water, halogens and metals compared to the untreated crude pyrolysis oil.

1.-15. (canceled)

16. A process for improving the quality of a crude pyrolysis oil originating from a pyrolysis of plastic waste, the process comprising:
providing a crude pyrolysis oil originating from the pyrolysis of plastic waste;
adjusting the pH value of the crude pyrolysis oil, resulting in a pretreated crude pyrolysis oil;
performing a solid-liquid-separation of solid components and liquid components of the pretreated crude pyrolysis oil and/or
subjecting the pretreated crude pyrolysis oil to a liquid-liquid-separation.

17. The process of claim 16, wherein the pH value of the crude pyrolysis oil is adjusted to be to about 6.5 or less.

18. The process of claim 16, wherein the pH value of the crude pyrolysis oil is adjusted to be about 8 or more.

19. The process of claim 16, wherein performing the solid-liquid-separation comprises filtering of the pretreated crude pyrolysis oil, wherein optionally one or more filter aids are added to the pretreated crude pyrolysis oil before filtering the same.

20. The process of claim 19, wherein an average filtration velocity during the filtering of the pretreated crude pyrolysis oil is about 0.04 kg/(h·cm²) or more.

21. The process of claim 19, wherein one of the one or more filter aids comprises diatomaceous earth, cellulose, perlite or mixtures thereof or consists of diatomaceous earth, cellulose, perlite or mixtures thereof and/or wherein the one or more filtering aids are used in an amount of about 0.5 g filter aid/g solid or more and/or about 90 g filter aid/g solid or less.

22. The process of claim 16, wherein the solid-liquid-separation is performed by using gravimetric forces or centrifugal forces or by building up a pressure difference.

23. The process of claim 16, wherein the liquid-liquid-separation is an extraction and/or is performed by mixing the pretreated crude pyrolysis oil with an extraction solution.

24. The process of claim 16, wherein the liquid-liquid-separation is performed at a temperature of about 25° C. or more, and/or about 150° C. or less.

25. The process of claim 16, wherein the crude pyrolysis oil and/or the pretreated crude pyrolysis oil is treated at a low shear rate.

26. The process of claim 16, wherein after the solid-liquid-separation and/or the liquid-liquid-separation, a further liquid-liquid-separation is performed.

27. The process of claim 26, wherein for the further liquid-liquid-separation one or more internal structural elements are used.

28. The process of claim 16, wherein a residue and/or an organic phase and/or an aqueous phase which have been obtained from a further liquid-liquid-separation is recirculated and/or fed back to the pretreated crude pyrolysis oil.

29. The process of claim 16, wherein the pretreated crude pyrolysis oil is subjected to at least one further solid-liquid-separation.

30. Use of a purified pyrolysis oil obtained by the process as defined in claim 16 as feedstock for a cracker or as feedstock for a partial oxidation unit to produce syngas.
